(19) United States
(12) Patent Application Publication
(10) Pub. No.: US 2006/0141868 A1
(43) Pub. Date: Jun. 29, 2006

(54) Low profile power connector

(76) Inventor: Xuedong Ma, Jiangsu (CN)

Correspondence Address: Stephen Z Weiss;Molex Incorporated, 2222 Wellington Court, Lisle, IL, 60532, US

(21) Appl. No.: 10/545,180

(22) PCT Filed: Mar. 9, 2004
(86) PCT No.: PCT/US04/07330

§ 371 Date: Aug. 10, 2005

(30) Foreign Application Priority Data
Mar. 21, 2003 (CN) 03 2 38874.8

(51) Int. Cl. H01R 24/04

(52) U.S. Cl. 439/668

(57) ABSTRACT

A low profile power connector comprises an insulative housing having front and rear faces which respectively define a jack cavity and a hole base communicating with the jack. The hole base including an insertion limiting portion having a through hole. Opposed internal sidewalls of the hole base respectively defining a left embedding slot and a right embedding slot, and an internal bottom wall of the hole base defining a bottom embedding slot. A first terminal is inserted into the hole base, and is inserted until it contacts the insertion limiting portion. A conductive piece is disposed in the right embedding slot of the hole base, and electrically engages the first terminal. A second terminal for grounding is disposed in the left embedding slot of the hole base. A third terminal for controlling is disposed in the bottom embedding slot of the hole base.

### FIELD OF THE INVENTION

The present invention relates to a low profile power connector, and more particularly to a low profile power connector which is used in a mobile phone to be connected to a charger or a power supply.

### BACKGROUND OF THE INVENTION

Referring to FIGS. 1, 2 and 3, a group of connectors in the prior art are disposed in one end of a mobile phone 1. A power connector 2 of the group of connectors has a jack cavity 204 for mating with a plug 31 of a mating power connector 3.

The power connector 2 has an insulative housing 20 with front and rear faces 201, 202. An insertion limiting portion 203 has a though hole 2031. First to third terminals 21 to 23 and a conductive piece 24 are disposed in the housing 20. The first terminal 21 is positioned within the through hole 2031 of the insertion limiting portion 203. The conductive piece 24 is located about a fixed end of the first terminal 21 for supplying power thereto. The second terminal 22 is located in one sidewall of the housing 20. The third terminal 23 is located in a top wall of the housing 20. The plug 31 of the mating power connector 3 can electrically engage the first to third terminals 21 to 23 when it is inserted into the jack cavity 204 of the power connector 2 to electrically engage a charger or power supply. New mobile phones are being designed to be smaller and thinner. Because the third terminal 23 is arranged in the top wall of the housing 20, the height of the connector housing 20 in the prior art cannot be reduced and cannot meet the thin and small requirements.

### SUMMARY OF THE INVENTION

As illustrated above, there is a need to reduce the height of the power connector used in the mobile phones in the prior art Therefore, an object of the present invention is to provide a low profile power connector to make the dimensions of mobile phone smaller and the weight lighter.

A low profile connector according to the present invention includes an insulative housing having front and rear faces. The front and rear faces respectively define a jack cavity and a hole base communicating with the jack cavity. The hole base includes an insertion limiting portion having a through hole. Opposed internal sidewalls of the hole base respectively define a left embedding slot and a right embedding slot, and an internal bottom wall of the hole base defines a bottom embedding slot. A conductive piece is provided which has a soldering portion, a base portion and a conductive portion which are integrally connected to one another. The conductive portion includes a though hole 4421. The base portion 441 is disposed in the right embedding slot of the hole base. A first terminal with a mating portion and a connecting portion is inserted into the through hole of the insertion limiting portion and the through hole of the conductive portion respectively. A second terminal portion is provided having a soldering section, a base section, a bending section and a spring connecting portion. The base section is disposed in the left embedding slot of the hole base. A third terminal is provided having a soldering portion, a base portion, and a spring connecting portion where the base portion is disposed in the bottom embedding slot of the hole base.

The base portion of the conductive piece is connected between the conductive portion and the soldering portion and forms a bend. The soldering portion is formed by bending a bottom edge of an other end of the base portion. The projecting portion of the first terminal is clamped between the conductive portion and the limiting portion, and the mating portion of the first terminal terminals with the through hole of the conductive piece.

The bending section is connected between one end of the base section and one end of the spring terminal arm, the soldering section is formed by bending a bottom edge of an other end of the base section, and the spring terminal arm extends to a predetermined position of a left side of the hole base. The base section of the third terminal is connected between the spring terminal arm and the soldering section, the soldering section is formed by bending a side edge of the base section, and the spring terminal arm extends to a predetermined position of a bottom side of the hole base. Side edges of base section of the second terminal, the third terminal and the conductive piece further form a plurality of interference projections respectively.

The advantages of the present invention is due to the third terminal, which was previously disposed in the internal top wall, is now disposed in the bottom embedding slot of the bottom wall of the hole base. Therefore, the space which was previously taken up by the third terminal is open reducing the housing height so as to meet the thin and small requirement, and furthermore, to make the entire mobile phone thinner and smaller.

### BRIEF DESCRIPTION OF THE DRAWINGS

The features of this invention which are believed to be novel are set forth with particularity in the appended claims. The invention, together with its objects and the advantages thereof, may be best understood by reference to the following description taken in conjunction with the accompanying drawings, in which like reference numerals identify like elements in the figures and in which:

FIG. 1 is an exploded perspective view of a conventional power connector of a mobile phone in the prior art and a mating power connector.

FIG. 2 is a cross-sectional view of the power connector of FIG. 1.

FIG. 3 is a view along the mating direction of the power connector of FIG. 2.

FIG. 4 is an exploded perspective Tear view of the present invention.

FIG. 5 is an exploded perspective front view of the first to third terminals of the present invention.

FIG. 6 is another exploded perspective rear view of the insulative housing of present invention.

FIG. 7 is an assembled perspective view of the present invention of FIG. 4.

FIG. 8 is rear view of the present invention of FIG. 7.

FIG. 9 is an assembled perspective front view of the present invention.

FIG. 10 is a front view of the present invention of FIG. 9.

### DETAILED DESCRIPTION OF THE INVENTION

Referring to FIG. 4, the present invention provides a low profile power connector. The low profile power connector 4 can either exist separately or be disposed in a low profile connector model 400. The connector model 400 may further include other connectors (such as sound connectors) in additional to the power connector 4.

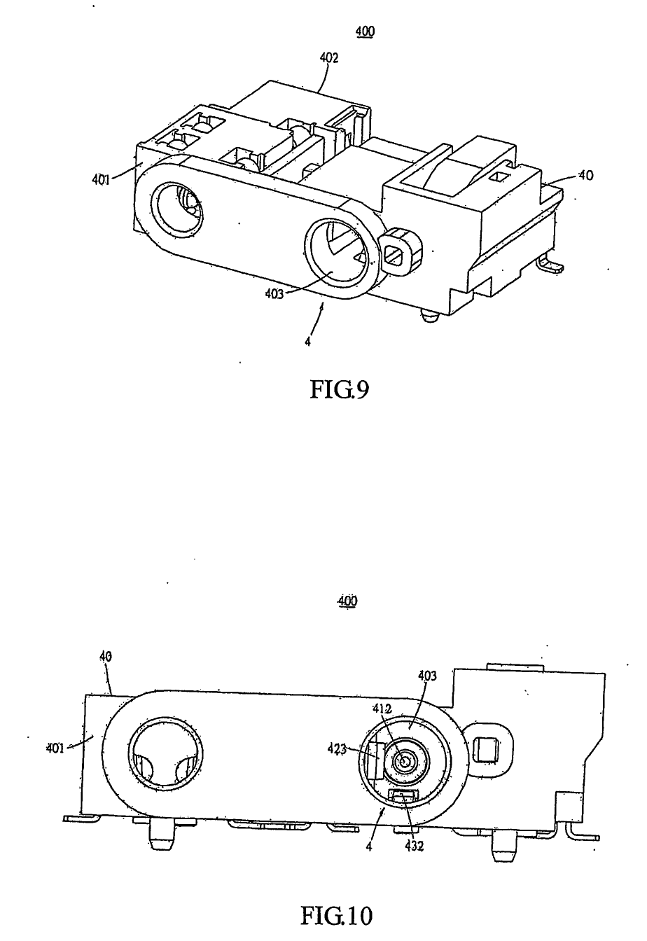

Because the connector model 400 (or the power connector 4 itself) must have reduced height, its internal components need to be designed so that height can be minimized. Referring to FIGS. 4 and 5, the power connector 4 comprises an insulative housing 40, a plurality of terminals and a conductive piece 44. The insulative housing 40 has front and rear faces 401, 402, and, as shown in FIGS. 4, 9 and 10, the front and rear faces 401, 402 respectively define a jack cavity 403 and a hole base 404 communicating with the jack cavity 403.

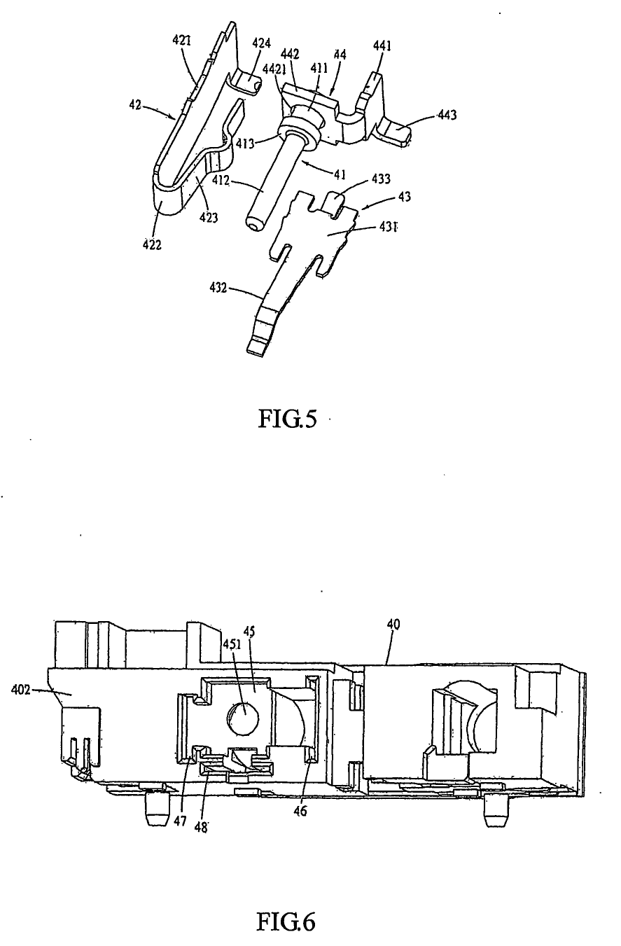

Referring to FIG. 6, an insertion limiting portion 45 has a through hole 451 disposed in the hole base 404 of the insulative housing 40. Opposed internal sidewalls of the hole base 404 respectively define a left embedding slot 46 and a right embedding slot 47. The internal bottom wall of the hole base 404 defines a bottom embedding slot 48. Each of the embedding slots 46, 47, 48 are located within the hole base 404.

The plurality of terminals and the conductive piece 44 are shown in FIG. 5. Referring to FIGS. 6, 7 and 8, the plurality of terminals include a first terminal 41, a second terminal 42 and a third terminal 43. The conductive piece 44 has a base portion 441, a conductive portion 442 and a soldering portion 443. The conductive portion 442 has a though hole 4421. The base portion 441 is connected between the conductive portion 442 and the soldering portion 443, and the base portion 441 and the conductive portion 442 are connected to each other with a curved portion. The soldering portion 443 is formed by bending a bottom edge from the base portion 441. The base portion 441 of the conductive piece 44 is disposed in the right embedding slot 47 of the hole base 404.

The first terminal 41 has a mating portion 411, a contacting portion 412 and a projecting collar 413. The projecting collar 413 is formed at the end of the mating portion 411 opposite the contacting portion 412. The contacting portion 412 is inserted into the through hole 451 of the limiting portion 45 (not shown). The mating portion 411 is inserted into the through hole 4421 of the conductive portion 442 for electrical connection thereto. The projecting collar 413 is clamped between the conductive portion 442 and the limiting portion 45 (not shown). The conductive portion 442 is connected to one end of the base 441 by a first bent portion. The soldering portion 443 is connected to another end of the base 441 by a second bent portion.

The second terminal 42 forms a base section 421, a bending section 422 extending from the base, a spring terminal arm 423 extending from the bending section and a soldering section 424 extending from the base. The soldering section 424 is formed by bending a portion of the base section 421. The base section 421 of the second terminal 42 is disposed in the left embedding slot 46 of the hole base 404, and the spring terminal arm 423 extends to a predetermined position on the left side of the hole base 404 into the jack cavity 403.

The third terminal 43 has a base portion 431, a resilient terminal arm 432 and a soldering portion 433. The base portion 431 is connected between the spring terminal arm 432 and the soldering portion 433, and the soldering portion 433 is formed by bending the edge of the base portion 431. The base portion 431 of the third terminal 43 is disposed in the bottom embedding slot 48 of the hole base 404, and the spring terminal arm 432 extends to a predetermined position of the bottom side of the hole base 404.

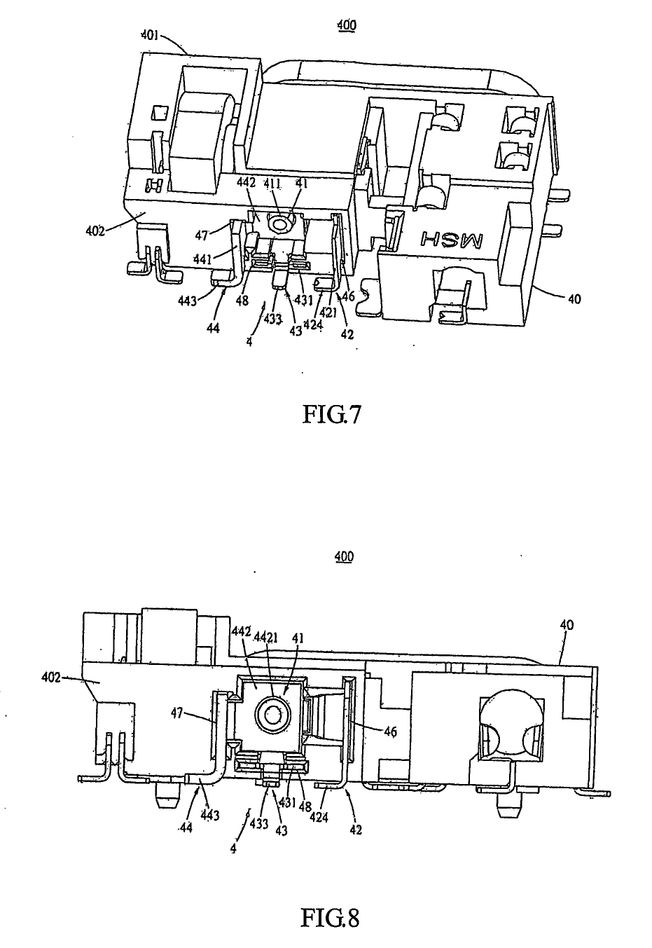

Referring to FIG. 7, the base portions 421, 431 and 441 of the second terminal 42, the third terminal 43 and the conductive piece 44 respectively contact the edges of the walls of corresponding embedding slots (47, 48, 26) respectively, and have a plurality of interference projections for mechanically engaging the corresponding walls of the slots, so that the second terminal 42, the third terminal 43 and the conductive piece 44 are fixed to the housing.

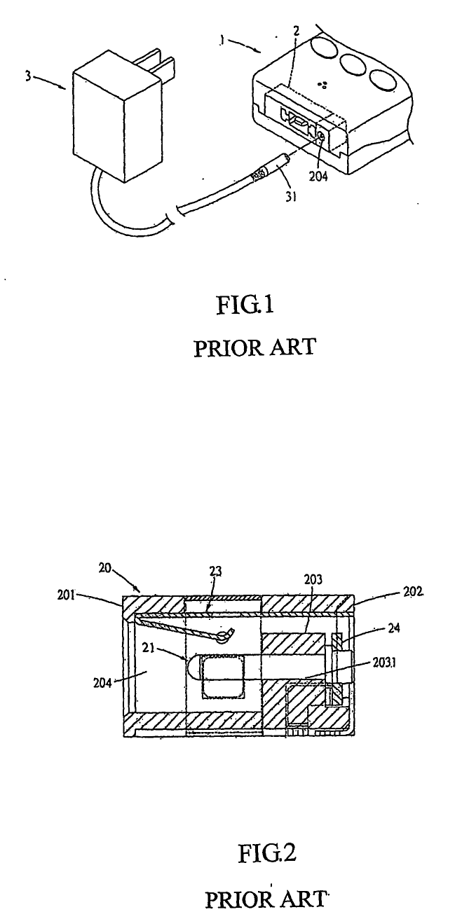

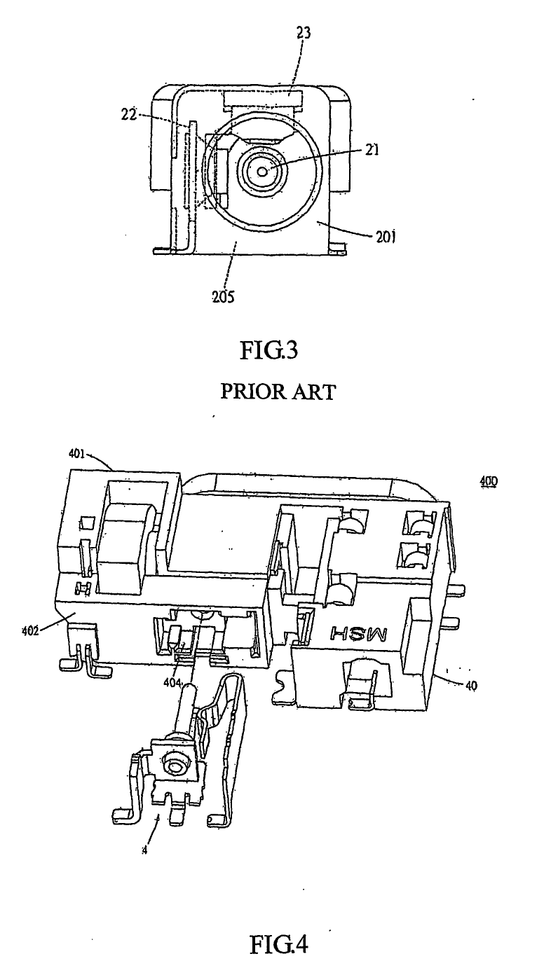

Referring to FIGS. 4 to 10, with regard to the function of the terminals, the first terminal 41 may receive the positive power from the mating power connector 3 (as shown in the FIG. 1) and the second terminal 42 may be used as a grounding terminal. The third terminal 43 is used as a switch so that the existence of the mating power connector 3 is sensed in the jack cavity 403 turning it into a quick charge module. Once inserted the mating power connector 23 first contacts the spring terminal are 432 of the third terminal 43 so that the circuit of the circuit board senses its presence. Then connector 3 contacts spring terminal arm 423 of the second terminal 42 and pushes on the free end of the spring terminal arm 423 to achieve grounding. Finally the contact portion 412 of the first terminal 41 is electrically engaged by the mating power connector 3 and receives the positive power thereof. Therefore, the power is received by the above-mention terminals from the mating power connector 3 and is transmitted to the printed circuit board by the soldering portions 443, 424, and 433.

Referring to FIG. 7, after the assembly of the power connector 4 of the present invention, the soldering portions 443, 433 and 424 which extend behind the rear face of the housings, as shown in the drawings, are soldered to the predetermined positions on the circuit board (not shown). Because the third terminal 43 of the present invention is located in the bottom and not the top of the housing the height of the housing is reduced. Furthermore, the height of top wall of the insulative housing is reduced to obtain the object of reducing the height of the insulative housing 40.

Although several embodiments of the present invention have been illustrated and described, it is not intended to limit the present invention. Rather, those slilled in the art may make various modifications of the invention without departing from the spirit and scope of the present invention. So, what the present invention intends to protect is based on the claims defined by the present application.

What is claimed is:

1. A low profile power connector, comprising:
an insulative housing having front and rear faces, the front and rear faces respectively including a jack cavity and a hole base communicating with the jack cavity, the hole base including an insertion limiting portion having a through hole, opposed internal sidewalls of the hole base define a left embedding slot and a right embedding slot, and an internal bottom wall of the hole base defines a bottom embedding slot,
a conductive piece having a soldering portion, a base portion and a conductive portion formed integrally, the conductive portion including a though hole, the base portion being disposed in the right embedding slot of the hole base;
a first terminal having a mating portion, a contacting portion, and a projecting collar integrally formed, the contacting portion being inserted into the through hole of the insertion limiting portion and the mating portion being inserted into the through hole of the conductive portion respectively;
a second terminal portion having a soldering portion, a base section, a bending section and a spring contacting portion formed integrally, the base section being disposed in the left embedding slot of the hole base; and
a third terminal having a soldering portion, a base portion, and a spring contacting portion formed integrally, the base portion being disposed in the bottom embedding slot of the hole base

2. The low profile power connector of claim 1, wherein the base portion of the conductive piece is connected to the conductive portion by way of a first bent portion and the soldering portion is connected to the base by way of a second bent portion.

3. The low profile power connector of claim 1, wherein the projecting collar of the first terminal is clamped between the conductive portion and the insertion limiting portion.

4. The low profile power connector of claim 1, wherein one end of the base of the second terminal is connected to the spring arm by way of a bent portion and another end of the base is connected to the soldering portion by way of a bent portion, the spring terminal arm extending to a predetermined position on a left side of the hole base.

5. The low profile power connector of claim 1, wherein the base portion of the third terminal is connected between the spring terminal arm and the soldering portion thereof, the soldering portion formed from a bend of a side edge of the base portion, and the spring terminal arm extending to a predetermined position on a bottom side of the hole base.

6. The low profile power connector of claim 1, wherein side edges of the base sections of the second terminal, the third terminal and the conductive piece further have a plurality of interference projections which mechanically engage walls of a respective embedding slot.

7. A low profile power connector, comprising:
an insulative housing having front and rear faces, the front and rear faces respectively defining a jack cavity and a hole base communicating with the jack cavity, the hole base having an insertion limiting portion with a through hole, opposed internal sidewalls of the hole base respectively defining a left embedding slot and a right embedding slot, and an internal bottom wall of the hole base defining a bottom embedding slot;
a first terminal inserted into the hole base until a projecting collar on the first terminal engages the insertion limiting portion;
a conductive piece disposed in the right embedding slot of the hole base, and electrically engaging the first terminal;
a second terminal for grounding disposed in the left embedding slot of the hole base; and
a third terminal for controlling, wherein the third terminal is disposed in the bottom embedding slot of the hole base.
